(19) United States
(12) Patent Application Publication
(10) Pub. No.: US 2010/0276455 A1
(43) Pub. Date: Nov. 4, 2010

(54) DISPENSER OF LIQUID OR VISCOUS PRODUCT

(75) Inventors: Jean-Yves Corbin, Thaon (FR); Mathias D'estais, Caen (FR); Laurent Clisson, Bourg-La-Reine (FR)

Correspondence Address: OSHA LIANG L.L.P., TWO HOUSTON CENTER, 909 FANNIN, SUITE 3500, HOUSTON, TX, 77010, US

(73) Assignee: CAPITAL INNOVATION (SARL), St. Ouen Cedex (FR)

(21) Appl. No.: 12/811,850

(22) PCT Filed: Jan. 7, 2009
(86) PCT No.: PCT/FR09/00005

§ 371 Date: Jul. 7, 2010

(30) Foreign Application Priority Data
Jan. 9, 2008 (FR) 0800133

(51) Int. Cl. B67D 7/06; B65D 37/00

(52) U.S. Cl. 222/205; 222/207; 222/321.8; 222/372

(57) ABSTRACT

Dispenser of liquid or viscous product, characterised in that it comprises a cup (3, 17) to receive the product, a sole piece to support the dispenser, a pump, comprising a pump body (13) and a piston, to transport the product from a reserve of product up to the cup (3, 17), the sole piece and the cup (3, 17) being connected by a hinge, the pump being inserted between the sole piece and the cup (3, 17) so as to transport the product when the piston is squashed on the pump body (13) by the movement of the cup (3, 17) in relation to the sole piece, the cup (3, 17) and the sole piece extending beyond the pump in relation to the hinge to enable the squashing of the piston on the pump body (13) by a user pressing with a utensil on the cup (3, 17).

The invention relates in particular to a dispenser of liquid or viscous product for dishwashing or cosmetics, operable by means of a washing utensil held in only one hand by a user, for dishwashing, or with reduced effort until inducing a sensation of caress, for cosmetics.

### STATE OF THE PRIOR ART

European patent EP 0 452 260 of the inventor Naumann is known from the prior art. This document discloses a pump for a liquid or viscous product and a dispenser of said product composed of a pot of product extending vertically, situated under a pump intended to extract the product when a user presses on the pump, the pressing being exercised via a horizontal cup surmounting the pump. Nevertheless, such a pot is naturally unstable when it is operated by means of a washing utensil held in only one hand by a user, since the effort on the utensil cannot be absolutely vertical and is certainly exerted in the polygon of support of the pot. The device of the document is all the more unstable the greater the volume of product to be contained, this making it necessary to extend the pot vertically, given that the base of the pot has to take up a reduced place on the sink or in a bathroom. Such a pot is unsuited to use as a dispenser operable by means of a washing utensil held in only one hand by a user, in the field of the invention, on account of the layout of the pump of the document between the dispensing cup and the pot of product.

European patent EP 1 114 606 of the inventor Maddox is known from the prior art. This document discloses a pouch dispenser of product, intended to be hung on a wall, and provided with a pump dispensing a product directly into the hand of a user and not into a cup. Such a pouch dispenser, arranged horizontally, is inoperable by means of a washing utensil held in only one hand by a user, the field of the invention, since pressing on top of the push bar causes the product to outflow under said bar without the possibility of recovering the product subsequently in the absence of a cup, and leading to soiling.

Pump pots for dispensing liquid or viscous products are known in the cosmetics field. They enable a product to be taken from a reservoir and to dispense it to a user on a cup by the user pressing on said cup with his hand. To this end, these pots use a pump provided with an inlet for the product, an outlet for the product and a piston, which is a part of the pump suited to making the product circulate from the inlet to the outlet of the pump, under the effect of the hand of the user pressing on the piston.

In these pots, the inlet of the pump has a plunger part introduced into the reservoir of product and its outlet has an orifice that opens into the cup. The cup is, moreover, made integral with the piston of the pump.

In this configuration, a pressing by the hand of the user on the cup, connected to the piston, induces the extraction of the product from the reservoir by the plunger and its dispensing via the orifice into the cup.

Nevertheless, pump pots require a sufficiently high force such that it is not possible to obtain the dispensing of their product either with a damp sponge without expelling water from the sponge, or with a hand brush, such as that used to wash dishes. To use a pump pot as dispenser of dishwashing product, and to wash dishes with a washing utensil such as a sponge or a brush, it is thus necessary to put down the washing utensil, to press with the hand to obtain the outflow of the product into the cup then pick the utensil up again and finally take up the product with the utensil. Such a use is not very practical for the user from the point of view of ergonomics or economy of movement. Moreover, in a cosmetics use, a sensation of caress cannot be obtained with pump pots.

A pump pot of the prior art does not enable the dispensing of its contents by simple pressing of a utensil on the cup, nor its immediate take up, without letting go of the utensil or with reduced effort to simulate a sensation of caress.

Another solution in the form of a slit boot disclosed in French patent application FR 2856388 has also been proposed in the prior art.

A slit boot is a dispenser of liquid or viscous product composed of a reservoir for the product, in boot form, provided on the instep of said boot with a slit, which is an opening system easily deformable by a damp sponge type of utensil, without expelling water from it, or by a hand brush for dishwashing and which can give a sensation of caress to the user.

In this configuration, pressing on the slit with a utensil for dishwashing makes it possible to deform the slit and to obtain the outflow of product via the slit, under the effect of the higher pressure brought about at said slit by the effect of gravity on the column of product contained in the leg of the boot and air at atmospheric pressure, which is introduced above the surface of the product via an air inlet, valve or hole, arranged in the reservoir.

Nevertheless, such a slit boot, although it makes it possible to obtain the dispensing of the product from the reservoir into the cup with a utensil or weak effort, does not make it possible to assure a reproducible and reliable outflow of product as a function of the effort provided by the user, when the reservoir is emptied of its product as it is consumed. An increasing softness or poor reactivity of the outflow is thus felt progressively by the user during repeated uses of the dispenser until the level of liquid in the leg is equal to the altitude of the slit, the dispenser then ceasing to function. Moreover, the volume of product situated below the altitude of the slit up to the sole piece of the boot is destined to remain stagnant and to be subject to pollution. Slit boots are not compatible either with too viscous products, gravity being insufficient to make these products flow.

A slit boot does not enable the dispensing of the product on the instep of the boot by means of a utensil, with an outflow independent of the product consumed and its viscosity and in proportion to the pressing of the utensil on the slit, while continuing to require reduced effort from the user.

### Drawbacks of Solutions Known from the Prior Art

No device of the prior art is suited to producing a dispenser of liquid or viscous product for dishwashing, operable by means of a washing utensil held in only one hand by a user, in a stable and clean manner.

No device for the dispensing of a liquid or viscous product for dishwashing or in cosmetics is capable of producing, as such, an outflow of the product that it contains under the effect of the pressure of a utensil handled by a user or with reduced effort, independently of the product consumed.

In addition, it does not seem conceivable either to do away with the pump, which increases the effort necessary to operate a pump pot, since the product can no longer be dispensed, or conceivable to add a pump to the slit of a slit boot, the pressure of a utensil handled by a user then becoming insufficient to dispense the product from the slit boot.

### Solution Provided by the Invention

In this context, according to its most general acceptance, the invention relates to a dispenser of liquid or viscous product, which comprises a reservoir or reserve of product, which comprises a cup to receive the product, a sole piece, extending under the cup, to support the dispenser, a pump, comprising a pump body and a piston, to transport the product from a reserve of product up to the cup, the sole piece and the cup being connected by a hinge, the pump being inserted between the sole piece and the cup so as to transport the product when the piston is squashed on the pump body by the movement of the cup in relation to the sole piece, under the effect of a user pressing on the cup and the altitude of the cup (3, 17) being lower than the altitude of the top of the reserve of product.

According to a first alternative, the pump body is in contact with the cup and the piston is in contact with the sole piece during the squashing, and wherein the cup and the sole piece extend beyond the pump in relation to the hinge so that the pressing of the user can take place on the extension of the cup with a utensil or by a light touch of the hand.

According to a second alternative, the piston is in contact with the cup and the pump body is in contact with the sole piece during the squashing, and wherein the cup and the sole piece extend beyond the pump in relation to the hinge so that the pressing of the user can take place on the extension of the cup with a utensil or by a light touch of the hand.

Advantageously, the dispenser is provided with an air inlet valve in the reserve of product.

According to a particular embodiment, the pump transports the product to the cup through a slit.

According to an alternative, the cup is concave, its concavity being turned upwards, to conserve the product in its hollow at the disposal of the user after dispensing.

Advantageously, the sole piece is a working plane and the hinge is formed by contact of the cup, on the working plane, the pressing of the user taking place between the hinge and the pump.

The invention also relates to a cup for the implementation of an aforementioned dispenser, provided with a hinge, to fix said cup to a sole piece and to enable a user to press on the cup, to squash a pump, between the cup and the sole piece, and to control the dispensing of a liquid or viscous product.

It also concerns the application of such a dispenser to the dispensing of liquid or viscous product for dishwashing, or cosmetic product.

The description of the invention is given for two of its embodiments, with reference to the figures listed below:

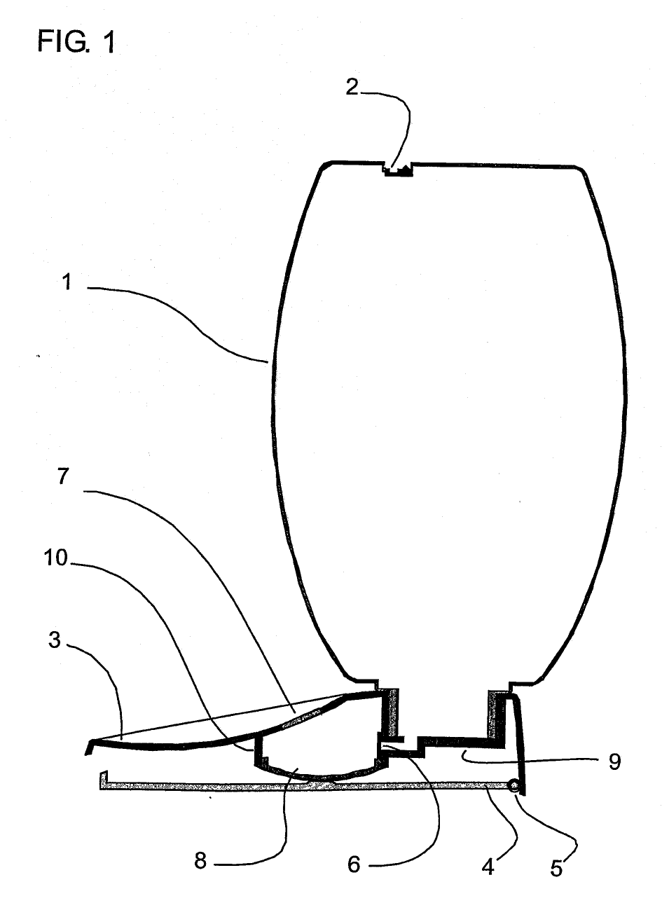

FIG. 1 represents, in section, a first embodiment of the invention for a pump in which the body, the non-deformable part of the pump, is in contact with the cup or connected to it.

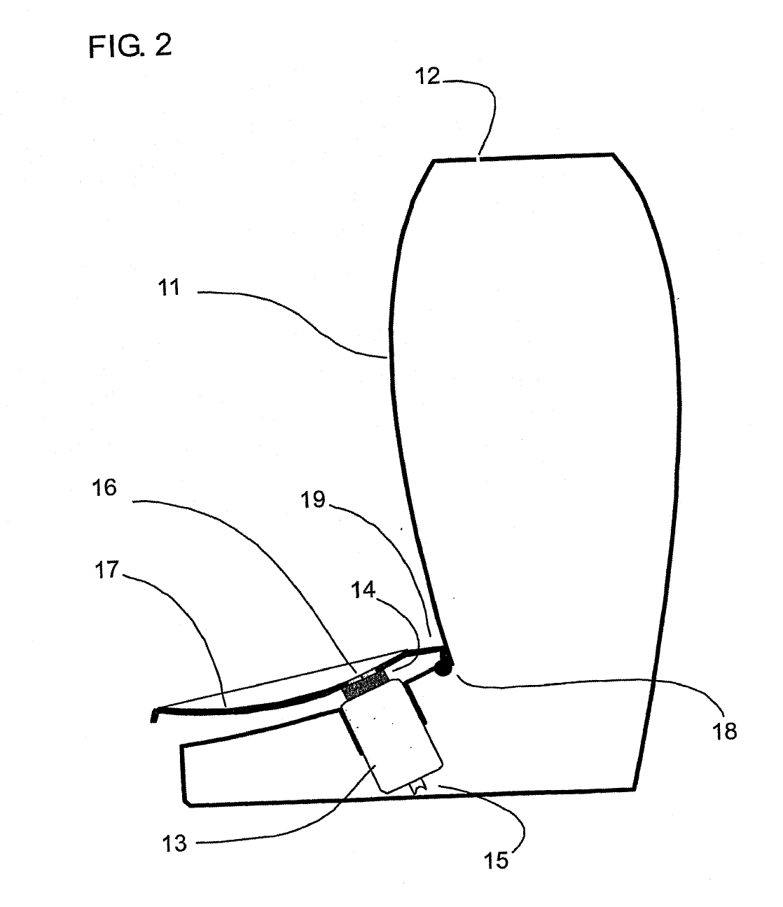

FIG. 2 represents, in section, a second embodiment of the invention for a pump in which the piston, the moving or deformable part of the pump, is in contact with the cup or connected to it.

In a first embodiment (FIG. 1) a dispenser according to the invention is constituted of a reserve of product or reservoir (1) intended to contain a liquid for dishwashing. Said reservoir is provided with a valve (2) to allow outside air to enter and it is screwed onto a cup (3) connected to a sole piece (4), intended to remain fixed, by a hinge (5). Hinge is taken to mean a link between the sole piece and the cup enabling at least one degree of freedom in rotation of the sole piece in relation to the cup, in other words enabling a bringing together of the two free ends of the cup and the sole piece when pressing on one of said ends. In this respect, a swivel could be envisaged for the invention in the case where the stability of the system would not be compromised by this choice. The hinge for the invention must also make it possible to squash the pump between the sole piece and the cup by bringing together these two components, in this respect, an elastic deformation without articulation of a U-shaped part, incorporating in a same assembly the sole piece and the cup could make it possible to obtain the effect of the invention, if the long term fatigue of the part is compatible with the desired application. A hinge enabling a rotation to a single degree of freedom around an axis constitutes nevertheless the preferred embodiment for the invention from a point of view of stability and mechanical strength.

The cup is connected to or incorporated in the non-deformable part or body (10) of a pump, which comprises a product inlet (6) forming non-return valve and a product outlet via a slit (7). The cup also comprises a piston (8) resting on the sole piece (4). The cup is thus in contact with the body of the pump when the pump is squashed.

It would be possible, in this embodiment, to locate on the cup (3) in the vicinity (9) of the product inlet (6), forming reservoir stopper, the air inlet valve in the reserve of product (2) so as not to modify the reservoir (1). The valve could however be located on any part of the dispenser in contact with the product of the reserve and through which air may be let into the reservoir. Such a part may be the base, which is the assembly constituted of the sole piece and the cup, or the reservoir. The valve may be defined from this point of view as an air inlet in the reserve of product.

The concave cup (3) and the sole piece (4) plate both comprise extensions beyond their contact points with the pump in relation to the hinge, in the sense where they extend to distances of the hinge greater than the greatest distances between the hinge and the points of the pump serving directly to transport the liquid, principally the body of the pump (10) and the piston. The sole piece extends under the cup, in so far as the projection, orthogonally to the sole piece or to the working plane on which the sole piece would rest, on the sole piece or on said working plane, of the cup, is of surface area substantially comparable or ideally slightly less than that of the sole piece. In this way, an effort on the cup falls within the polygon of support of the dispenser when it rests on its sole piece and the user pressing on the cup maintains a stable balance for the dispenser.

By virtue of their extensions, the cup and the sole piece enable the user who so wishes to obtain an outflow of product, to be able to press with a force divided by a coefficient substantially equal to the quotient of the distance of pressing to the hinge by the average distance of the pump, body and piston, to the hinge. The extension of the cup procures a lever effect to press on the piston (8) of the pump with less effort and the extension of the sole piece under the cup procures the stability of the device during the pressing of the user, for a cup and a sole piece connected or in contact via a hinge.

In this configuration, the reservoir (1), once empty, may be unscrewed and replaced by a replacement bottle, simply provided with a valve. The valve may be a simple hole. In this case, a breakable nipple could advantageously be provided on the reservoir, which makes it possible to form this hole easily. Thus, it is the user himself who can do this after having placed and connected his replacement reservoir on the base, constituted of the sole piece and the cup.

In a second embodiment (FIG. 2), a dispenser according to the invention is constituted of a reservoir (11) intended to contain a liquid for dishwashing. Said reservoir is provided with a valve or a hole or a bottle pourer (12) to allow outside air to enter and this reservoir is in the form of a boot and pierced with a hole suited to receiving a pump (13)(14)(15)(16) comprising a pump body (13), a piston (14), a liquid inlet (15) and a liquid outlet (16) via a slit or a valve. A cup (17) is incorporated in or connected to the moving or deformable part of the pump, or piston (14). The cup is thus in contact with the piston when the pump is squashed. The cup is connected to the reservoir (11) by a hinge (18) situated at the junction of the foot and the leg of the boot. The fixed sole piece of the dispenser according to the invention may be comfortably determined as the instep (19) of the boot, because it is here incorporated into the reservoir (11) which is fixed. In this configuration, it is possible to determine the extension of the sole piece according to the rule that the instep (19), which extends from the tip of the foot of the boot to the hinge must extend under the cup with a dimension comparable to it, to obtain the advantages of the invention. The assembly of the cup (17) may be achieved in this second embodiment by simultaneously building in the cup in the hinge (18) and the body of the pump (13) in the hole for the pump, arranged in the instep (19). In this version, the replacement of the empty reservoir (11) could be obtained by dismantling the cup (17) outside of the hinge (18) and dismantling the pump body (13) outside of the hole for the pump. The cup may thus be made dismantleable.

It should be noted, in the embodiments of the invention, that as long as the cup is situated at an altitude lower than that of the top of the reservoir, defined as the highest point of altitude in this component, the foot of the reservoir being, for its part, the lowest point of altitude, the pressing on the cup is very stable. This configuration could be preferred in the embodiment of the invention.

Likewise, the formation in a same part or incorporation or link of the cup and the pump body, or the piston and the cup, or the sole piece and the reservoir containing the reserve of product, are means of minimising the cost of realising the invention.

The dispenser of the invention will also be advantageously provided with an air inlet valve in the reserve of product enabling the outflow of the product without deformation of the reservoir during pumping. This avoids, in fact, an increase in the pumping effort as the product is consumed and the risks of air penetrating into the pump from the outside.

The reservoir could also be a flexible pouch, if necessary maintained within rigid components, in this case an air inlet valve in the reserve of product is then not necessary.

The cup will also be advantageously concave, of concavity turned upwards, towards increasing altitudes, to enable the conservation in its hollow of the product delivered by the pump.

The application to a dispenser of washing up liquid operated by a utensil such as a damp sponge while limiting the evacuation of water from the sponge or with a washing brush is not the only use of the invention.

The invention more generally makes it possible to reduce the effort necessary to operate a dispenser of liquid or viscous product.

The invention is thus also applicable to the operation of a pot of cosmetic product by lightly touching with the hand the cup of the invention. The extension of the cup then appears as the means of reducing the effort necessary to the operation of the pot of cosmetic product until giving the user the sensation of a light touch. Indeed, a reduction as far as necessary in the effort to be provided may be obtained by increasing more and more the extension of the cup and the sole piece facing the cup, these extensions being measured from the hinge. It is thus possible for those skilled in the art to adapt the invention to variable firmnesses of pump or viscosities of product so as to only require a limited effort, by the user, to operate a dispenser of liquid or viscous product implementing the invention. The effort will correspond for example to the use of a washing utensil in the case of a dispenser of dishwashing liquid or obtaining a sensation of caress or light touch of the cup with the hand in the case of a dispenser of cosmetic product and the simple adaptation of dimension of the cup and the facing sole piece, measured from the hinge, will make it possible to obtain the desired result.

Apart from the two embodiments presented, the invention may be realised according to alternatives.

A first alternative relates to the position of the air inlet valve in the reserve of product or reservoir. If such a valve intended to balance out the pressure with the outside when the level of product drops in the reservoir consecutive to dispensing is placed on the reservoir, it is then necessary to modify existing reservoirs to use them with the invention. On the other hand, if this valve is positioned on a part of the device outside of the reservoir and in contact with the product contained in the reservoir then the invention may be adapted to existing reservoirs, which constitutes an advantage. Such a valve only also has to be situated outside of the pump so as not to disrupt the operation of the invention. A part of the device close to the location of the outlet of the reservoir may be chosen.

A spout situated in the upper part of the reservoir, that can be used as such and also act as air inlet has also been described previously.

In the same spirit as the preceding alternative, said spout may be located on a part of the device outside of the reservoir and in contact with the product contained in the reservoir. Said spout may be designed in the form of a valve sealed at low pressure to withstand gravity pressure of the liquid and routine handling of the bottle, and open to flow under a significant pressure induced by compression of the hand on the bottle. Both functions could also be fulfilled, outflow of liquid under pressure and inflow of air to compensate the pressure difference between the bottle and the outside when the level of product drops in the reservoir consecutive to dispensing, with a single valve, for example a simple slit elastomer skin can satisfy both functions.

Likewise, a limit alternative of the invention for a low extension of the cup beyond the pump could be noted, the pressing of the user taking place practically at the level of the pump, the caress effect being low. In this case, the hinge link is hardly or even not called upon by the pressing of the user and a simple contact in at least two points of the cup with a working plane, forming sole piece, is sufficient to form a hinge. The cup rests on the pump in at least one other point and the pump rests on the working plane. The stability is nevertheless less good and the comfort of use is reduced in this alternative embodiment of the hinge connection. The teaching of the invention may nevertheless be used in this limit hinge link configuration to economise the material of the sole piece, this no longer being necessary. In this configuration, the pressing of the user may take place on the cup between the hinge and the pump, in other words between the points of the cup in contact with the working plane and that or those in contact with the pump. The user feels in this alternative an effect of an increase in the effort to provide to make the dispenser operate when the point where the user exercises the pressure on the cup comes closer to the hinge. It is thus possible to increase the effort necessary to use a dispenser according to the invention and obtain an effect of increased firmness for the user, while enabling a pressing by the user, on the cup of the invention, between the pump and the hinge.

Finally, the cup of the dispenser according to the invention may be commercialised alone, the sole piece being simply provided, to accommodate the hinge of the cup or to create the hinge by association of means on the cup and on the sole piece or instead to accommodate on the cup a hinge situated on the sole piece. These cases are considered with regard to the present application as equivalent to the case where the cup is provided with a hinge, the fastening of this hinge being possible on the sole piece.

In view of the present application as a whole, the invention thus appears as a means of adjusting the effort required by a user, in the sense of an increase, a reduction or at the limit of a stability of effort, to use dispensers of liquid or viscous products.

The invention makes it possible, in all its generality, to have available for the design of dispensers of liquid or viscous products, a means of adapting the effort required by the use of a pump, in terms of efficiency of dispensing a product, at the desirable effort for a user, in terms of ergonomics.

The invention is capable of industrial application in the field of producing dispensers of washing up liquid or cosmetic products.

1. A dispenser of liquid or viscous product, comprising a reservoir or reserve of product, the dispenser comprising:
a cup to receive the product;
a sole piece, extending under the cup, to support the dispenser;
a pump comprising a pump body and a piston, wherein the pump is configured to transport the product from the reserve of product up to the cup,
wherein the sole piece and the cup are connected by a hinge, the pump being inserted between the sole piece and the cup so as to transport the product when the piston is squashed on the pump body by movement of the cup in relation to the sole piece, under an effect of a user pressing on the cup, and
wherein the altitude of the cup is lower than the altitude of a top of the reserve of product.

2. The dispenser according to claim 1, wherein the pump body is in contact with the cup and the piston is in contact with the sole piece during the squashing, and wherein the cup and the sole piece extend beyond the pump in relation to the hinge so that pressure applied by the user can take place on an extension of the cup with a utensil or by a light touch of a hand.

3. The dispenser according to claim 1, wherein the piston is in contact with the cup and the pump body is in contact with the sole piece during the squashing, and wherein the cup and the sole piece extend beyond the pump in relation to the hinge so that pressure applied by the user pressing on the cup occurs on an extension of the cup with a utensil or by a light touch of a hand.

4. The dispenser according to claim 1, further comprising an air inlet valve in the reserve of product.

5. The dispenser according to claim 1, wherein the pump transports the product up to the cup through a slit.

6. The dispenser according to claim 1, wherein the cup is concave, its concavity being turned upwards, to conserve the product in its hollow at the disposal of the user after dispensing.

7. The dispenser according to claim 1, wherein the sole piece is a working plane and the hinge is formed by contact of the cup on the working plane, wherein pressure from the user pressing on the cup occurs between the hinge and the pump.

8. A cup for the implementation of a dispenser according to claim 1, comprising:
a hinge to fasten the cup to a sole piece and to enable a user to press on the cup to squash a pump disposed between the cup and the sole piece, wherein the pump is used to control the dispensing of a liquid or viscous product.

9. The dispenser according to claim 1, wherein the dispenser is for dispensing of liquid or viscous product for dishwashing or a cosmetic product.
